(19) United States
(12) Patent Application Publication
(10) Pub. No.: US 2010/0101066 A1
(43) Pub. Date: Apr. 29, 2010

(54) DEVICE FOR ATTACHING A ROPE TO A HANDLE

(76) Inventors: Roberto Stein, Hamburg (DE); Kolja Krebs, Potsdam (DE)

Correspondence Address: WHITE & CASE LLP;PATENT DEPARTMENT, 1155 AVENUE OF THE AMERICAS, NEW YORK, NY, 10036, US

(21) Appl. No.: 12/596,097

(22) PCT Filed: Mar. 20, 2008
(86) PCT No.: PCT/EP08/02283

§ 371 Date: Oct. 15, 2009

(30) Foreign Application Priority Data
Apr. 16, 2007 (DE) 10 2007 018 221.1

(51) Int. Cl. B23Q 7/04

(52) U.S. Cl. 29/283.5

(57) ABSTRACT

According to the invention, a device for attaching a rope (8) to a handle (4), particularly of a tool, is characterized by at least a partially tube-shaped cover (20) that is elastically deformable at least in the circumferential direction of the tube shape and has an anchoring for the rope (8).

The present invention relates to a device for fastening a cord on a handle.

In order to prevent something from falling to the ground, it is known for example for pocket watches, spectacles, cameras or mobile phones—but, in the broader sense, also for many other articles—for these to be fastened on a cord which, in turn, is fastened somewhere on the user's body. For example, the watch chain has traditionally been fastened on the buttonhole of a waistcoat, and the rubber band of a ski pass has usually been fastened on a zipper eyelet.

The abovementioned articles are usually also designed in order to be connected to a cord. For this purpose, they have eyelets, bores, holes, tapered portions or the like. However, if it is desired to fasten on a cord an article which does not have a fastening device for a cord, problems quickly arise when an article is retrofitted with such devices: drilling a hole through damages the article; screwing in an eyelet works predominantly only for a very small number of materials; tying the cord around the article is ruled out if the articles are bulky—to name but a few of the problems. Even in the case of articles with a handle, for example in the case of tools (for example a screwdriver, hammer or pair of pliers), provision is not usually made for a securing cord to be fastened thereon.

The object of the present invention is therefore to provide a device which allows a cord to be fastened on a handle without the handle being irreversibly altered or damaged in the process.

This object is achieved by a device having the features of claim 1. Preferred configurations are given in the subclaims.

The device according to the invention for fastening a cord on a handle—in particular of a tool, for example a screwdriver, a hammer or a pair of pliers—has an elastically deformable cover with an anchoring means for the cord. The cover can be for example fitted, or unrolled, over the handle for example in the manner of a condom—at any rate is at least partially tubular and is elastically deformable at least in the circumferential direction of the tube shape, in which case the cover fitted over the handle closes elastically around the handle and cannot easily be pulled off by customary handling force. Preferably located at the tip of the cover is an anchoring means for the cord, for example an eyelet (which can preferably be rotated axially in order to release twisting in the cord).

It is known for handles, despite specific ergonomic requirements, to be of different thicknesses: the handle of a hammer is somewhat thicker than the handle of a pair of universal pliers or gas pliers, and the latter, in turn, is somewhat thicker than the handle of a pair of precision engineering pliers. The handle of a hatchet, in turn, is somewhat thicker than that of a hammer, while the handle of a screwdriver corresponds approximately, in diameter, to that of a hammer. Depending on the type of article which has the handle, that is to say in particular also depending on the type of tool, the handles are also contoured differently to a certain extent, have handle hollows or hand-impression profiles, are waisted in certain regions, as is often the case, for example, with screwdrivers, or are curved or bent slightly, as is the case, for example, with pliers. In order to allow for these various forms of handle, the elastic deformability of the cover according to the invention already makes it possible to fit snugly over a certain diameter range, and the cover can then be slipped over. The thinner-walled the cover according to the invention, and/or the more elastic its material, the better does the elastic cover mold to, and fit over, the various types of contour mentioned. In order, however, for it not to be necessary for example for a cover which is suitable for a precision engineering screwdriver, and of which the tubular region has a non-deformed internal diameter of approximately 8 mm, to be elastically deformed to an excessive extent (for example on a handle of a hatchet) (in which case it possibly ruptures), it is possible, and envisaged, according to the invention to produce the device according to the invention with different internal diameters: a device with a non-deformed internal diameter of 6 mm is then suitable, for example, for handles between 6 mm and 12 mm in diameter, an internal diameter of 10 mm is then suitable for handles between 10 mm and 20 mm and an internal diameter of 18 mm is suitable for handles between 18 mm and 36 mm. The elastic deformability means that the tubular cover of the device according to the invention, in its preferably non-deformed, essentially long-cylindrical form, is also suitable for flat-oval handles, as are commonly used for example for straightforward hammers, or precisely also for the abovementioned more complex forms of handle.

The device, at least in the region of the elastically deformable cover, is preferably made, for example molded or injection-molded, from an elastic material, for example from an elastomer such as silicone. However, the invention also provides for a cover which achieves its circumferentially elastic deformability by way of a woven fabric which is braided diagonally in relation to the direction of the tube axis.

The hitherto described, and further, aspects and advantages of the present invention will be described in more detail hereinbelow with reference to the accompanying drawings, in which exemplary embodiments of the invention are illustrated and in which

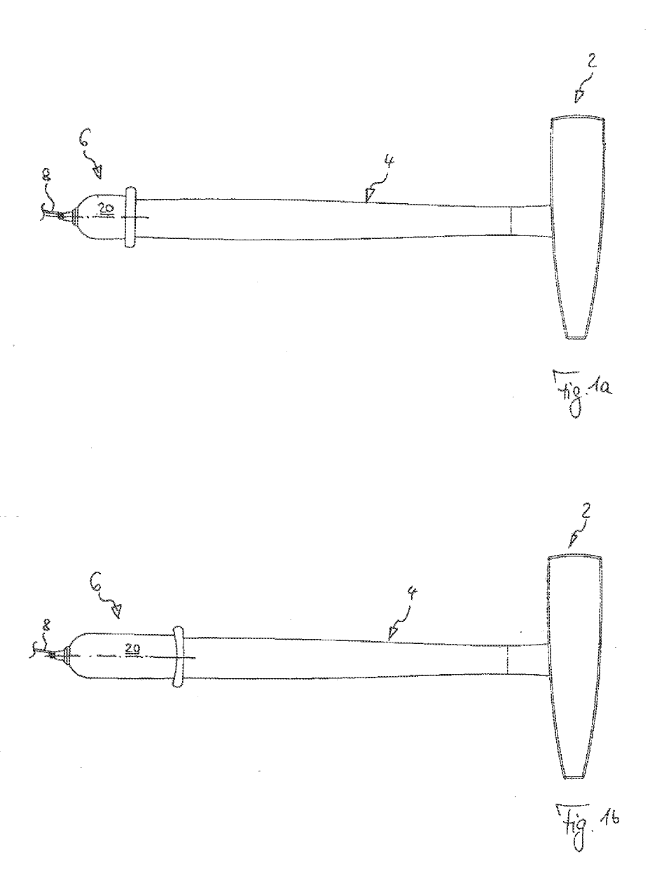

FIGS. 1a to c show a side view of the operation of mounting a device according to the invention on the handle of a hammer, and

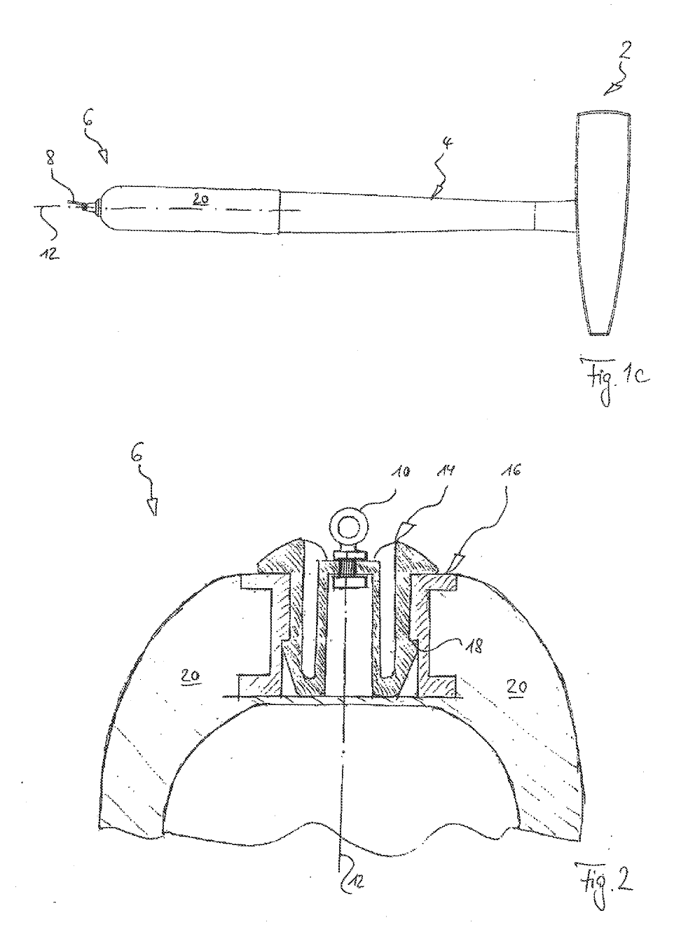

FIG. 2 shows a sectional side view of a means according to the invention for anchoring a cord on a device according to the invention.

FIG. 1c shows a hammer 2 with a device 6 according to the invention for fastening a cord 8 mounted at the end of its handle 4.

Looking at FIG. 2, the device 6 has an anchoring means 10 in the form of an eyelet to which the cord can be secured. The eyelet 10 is mounted, such that it can be rotated about its longitudinal axis 12, in a clip 14 which is essentially rotationally symmetrical (about the longitudinal axis 12). The clip 14 is plugged (from above in FIG. 2) into a bore sleeve 16 and secured in a form-fitting manner on a circumferentially encircling undercut 18 in the bore sleeve 16. The bore sleeve 16 is fitted at the end of the device 6, which also comprises a cover made of silicone 20. The cover 20 has an essentially elongate-cylindrical, tubular shape which is closed in a cup-like manner at one end, which is illustrated in FIG. 2. At this end of the device 6, the bore sleeve 16 is molded into the silicone of the cup-like cover 20 and, for intimate, in particular form-fitting connection to the silicone 20, has radially outwardly encircling flange peripheries 22 which project into the silicone 20 and thus result in a form-fitting action in particular against the sleeve 16 being pulled out in the direction of the axis 12.

Looking at FIGS. 1a to c, it can be seen that the cover 20 can be rolled up and unrolled in the direction of the axis 12: rolled up as in FIG. 1a, the cover 20 can be positioned on the end of the hammer handle 4 like a hat and then unrolled over the handle according to FIG. 1b in order finally, according to FIG. 1c, to form a more or less flush outer contour with the hammer handle 4. The device 6 is thus retained both on account of the slight oversize of the hammer-handle diameter in relation to the internal diameter of the cover 20 and by a suction force which arises when, as a result of axial pulling on the cord 8 at the end of the cover 20, the device 6 threatens to be pulled off from the hammer handle 4. This gives rise immediately, in the increasing interior space between the end of the hammer handle 4 and the cup-like end of the cover 20, where the anchoring means 10 is located, to an increasing cavity into which air cannot flow. This presupposes, however, that the arrangement of the anchoring means 10 here with the clip 14 and sleeve 16 closes the cup form of the cover 20 in an air-tight manner.

A more straightforward variant than that depicted would be one in which the eyelet 10 is molded directly into the silicone 20, this having the disadvantage of a lack of axial rotatability of the eyelet for untwisting the cord 8 and of it not being possible to release the cord 8 from the hammer handle by means of a clip 14.

1. A device for fastening a cord on a handle of an object, wherein the device comprises an elastically deformable cover and an anchoring means for the cord.

2. (canceled)

3. (canceled)

4. The device according to claim 1, wherein the elastically deformable cover is produced substantially from an elastic material.

5. The device according to claim 1, wherein the elastically deformable cover is adapted to be fitted onto the handle of the object by unrolling.

6. The device according to claim 1, wherein the anchoring means for the cord comprises a twisting-relief means which can be rotated about its longitudinal axis.

7. The device according to claim 1, wherein the object is a handyman's tool.

8. The device according to claim 1, wherein the elastically deformable cover comprises a tubular section that is deformable in a circumferential direction.

9. The device according to claim 8, wherein the tubular section of the elastically deformable cover has an inner contour that is substantially elongate-cylindrical.

10. The device according to claim 9, wherein the inner contour of tubular section of the elastically deformable cover corresponds, at least in part, to the shape and/or dimensions of the handle of the object.

11. The device according to claim 4, wherein the elastically deformable cover is produced by molding the elastic material.

12. The device according to claim 11, wherein the elastically deformable cover is produced by injection molding.

13. The device according to claim 6, wherein the twisting-relief means is a rotatable eyelet.

14. The device according to claim 6, wherein the twisting-relief means is a bore.
